(19) United States
(12) Patent Application Publication
(10) Pub. No.: US 2013/0333467 A1
(43) Pub. Date: Dec. 19, 2013

(54) Measuring Fluid Density

(71) Applicant: Waters Technologies Corporation, Milford, MA (US)

(72) Inventor: Joseph A. Jarrell, Newton Highlands, MA (US)

(21) Appl. No.: 13/908,261

(22) Filed: Jun. 3, 2013

Related U.S. Application Data
(60) Provisional application No. 61/661,454, filed on Jun. 19, 2012.

(51) Int. Cl. G01N 9/32

(52) U.S. Cl. CPC G01N 9/32
USPC 73/32 A

(57) ABSTRACT

An apparatus includes a vibration element defining a fluidic passageway; an excitation element for exciting vibration of the vibration element; a detector for providing a signal representative of the frequency excited; and control electronics configured to determine a density of a fluid flowing through the fluidic passageway based, at least in part, on the signal provided by the detector. The vibration element is configured such that Coriolis force induced twisting of the vibration element is substantially inhibited.

### RELATED APPLICATION

This application claims priority to and benefit of U.S. Provisional Patent Application No. 61/661,454 entitled “Measuring Fluid Density,” filed Jun. 19, 2012, which is incorporated by reference herein in its entirety.

### TECHNICAL FIELD

This disclosure relates to measuring fluid density.

### BACKGROUND

In supercritical fluid chromatography (SFC), the separation is often controlled by a back pressure regulator (BPR). The BPR is used to control the pressure at an outlet of a separation column or a high pressure detector. This pressure affects the density of the mobile phase, which, in turn affects the separation.

### SUMMARY

The disclosure is based, in part, on the realization that a more direct means of controlling and monitoring density of a mobile phase in a supercritical fluid chromatography (SFC) system can be possible by using a low volume, flow-through device to measure the density of the mobile phase passing through it and hence provide an output signal that can be used for control and monitoring.

One aspect provides an apparatus that includes a vibration element defining a fluidic passageway; an excitation element for exciting vibration of the vibration element; a detector for providing a signal representative of the frequency excited; and control electronics configured to determine a density of a fluid flowing through the fluidic passageway based, at least in part, on the signal provided by the detector. The vibration element is configured such that Coriolis force induced twisting of the vibration element is substantially inhibited.

Another aspect features A method that includes measuring a density of a mobile phase fluid in a chromatography system by passing the mobile phase fluid through a flow-through member of a DMD, and controlling operation of one or more other devices of the chromatography system based on the measured density.

In yet another aspect, a chromatography system includes a separation column; a pump for delivering a mobile phase fluid flow to the separation column; a vibration element defining a passageway in fluidic communication with the pump; an excitation element for exciting vibration of the vibration element; a detector for providing a signal representative of the frequency excited; and control electronics configured to determine a density of the mobile phase fluid flow based, at least in part, on the signal provided by the detector.

Implementations may include one or more of the following features.

In some implementations, the vibration element includes a u-shaped flow-through member that defines the fluidic pathway.

In certain implementations, the flow-through member includes a fused silica tube.

In some implementations, the flow-through member includes a diffusion bonded titanium substrate.

In certain implementations, the flow-through member includes an inlet segment and an outlet segment which are connected by a connecting segment, and the vibration element includes one or more cross-members which extend between the inlet and outlet segments to inhibit Coriolis force induced twisting of the vibration element.

Some implementations also include a housing defining a chamber. The vibration element is cantilever mounted within the chamber, and the chamber is evacuated to provide a vacuum.

In certain implementations, the detector is mounted external to the housing, and the housing includes at least one transparent wall to allow optical communication between the detector and the vibration element.

In some implementations, measuring the density of the mobile phase fluid in the chromatography system comprises: driving a vibration element that includes the flow-through member to vibrate; and monitoring the vibration motion of the vibration element with a detector of the DMD.

In certain implementations, driving the vibration element includes applying a sine-wave signal to an excitation element to excite vibration of the vibration element.

In some implementations, the vibration element includes one or more cross-members which inhibit Coriolis force induced twisting of the vibration element as it vibrates.

In certain implementations, controlling operation of the one or more other devices of the chromatography system includes adjusting a pressure setting of a back pressure regulator of the chromatography system, and thereby adjusting the density of the mobile phase fluid.

In some implementations, controlling operation of the one or more other devices of the chromatography system includes adjusting a flow rate from a solvent delivery pump.

In certain implementations, controlling operation of the one or more other devices of the chromatography system includes controlling operation of a proportioning valve to achieve desired proportions of solvents in the mobile phase fluid.

In some implementations, the control electronics are configured to adjust operation of the at least one pump based on the density of the mobile phase fluid flow.

Certain implementations also include a back pressure regulator for regulation an operating pressure of the system. The control electronics can be configured to adjust a pressure setting of the back pressure regulator based on the density of the mobile phase fluid flow.

Some implementations also include a proportioning valve for regulation an operating pressure of the system. The control electronics can be configured to adjust a pressure setting of the back pressure regulator based on the density of the mobile phase fluid flow.

In certain implementations, the chromatography system is supercritical fluid chromatography system.

In some implementations, the chromatography system is a liquid chromatography system

Other aspects, features, and advantages are in the description, drawings, and claims.

### BRIEF DESCRIPTION OF THE DRAWINGS

FIG. 1A is a cross-sectional side view of an apparatus for measuring the densities of fluids.

FIG. 1B is a cross-sectional plan view of a density-measuring device of the apparatus of FIG. 1A.

FIG. 1C is a cross-sectional end view of the density-measuring device of the apparatus of FIG. 1A.

FIG. 2 is a schematic view of a supercritical fluid chromatography (SFC) system including the apparatus of FIG. 1A.

FIG. 3A is a cross-sectional side view of another implementation of an apparatus for measuring the densities of fluids, which includes a density-measuring device that comprises a flow-through member formed from a diffusion bonded titanium substrate.

FIG. 3B is a cross-sectional plan view of the density-measuring device of the apparatus of FIG. 3A.

FIG. 4A is a cross-sectional side view of another implementation of an apparatus for measuring the densities of fluids, which includes a density-measuring device that comprises a flow-through member formed from fused silica capillary tubing.

FIG. 4B is a cross-sectional plan view of the density-measuring device of the apparatus of FIG. 4A.

FIG. 5 is a cross-sectional side view of another implementation of an apparatus for measuring the densities of fluids, which includes an externally mounted detector.

FIG. 6 is a schematic view of a liquid chromatography (LC) system including the apparatus of FIG. 1A.

FIG. 7 is a schematic view of another implementation of a liquid chromatography (LC) system including the apparatus of FIG. 1A.

Like reference numbers indicate like elements.

### DETAILED DESCRIPTION

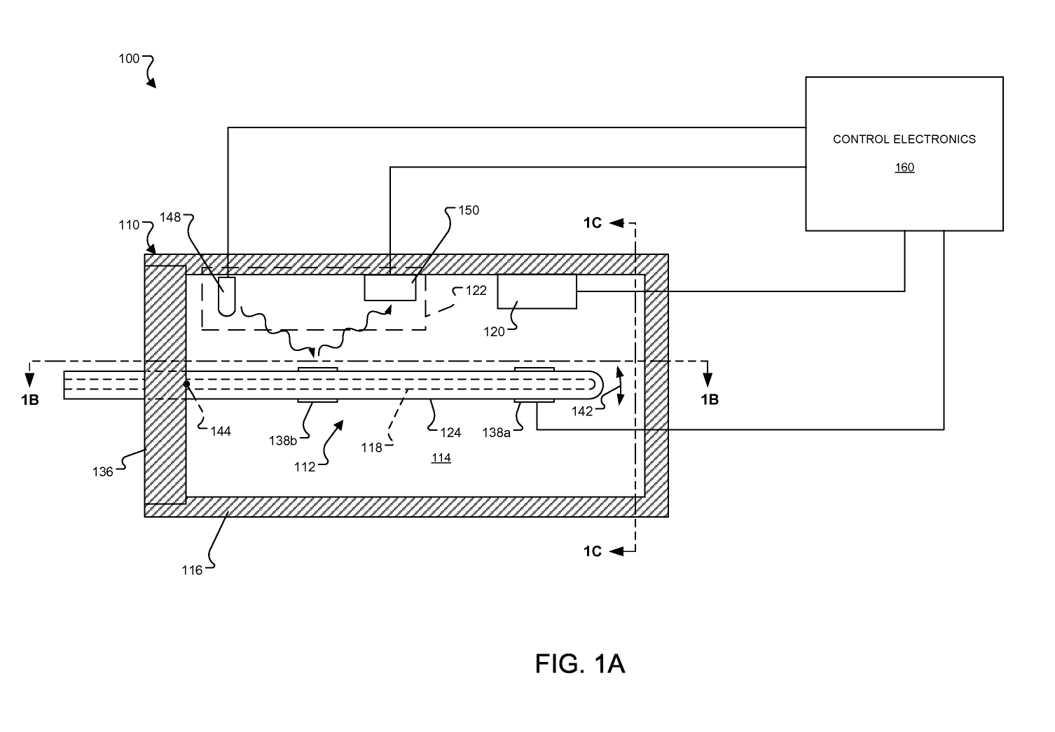

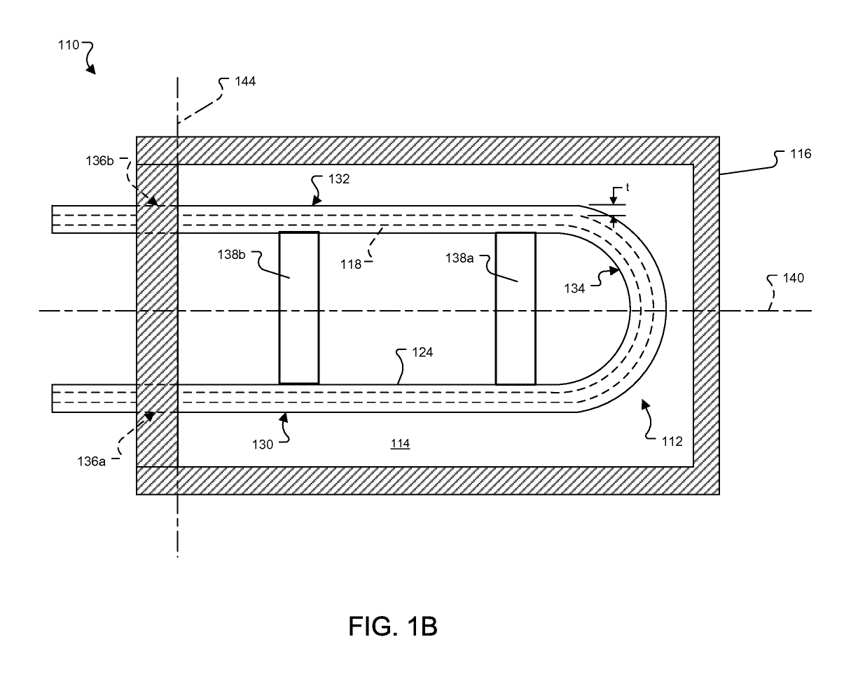

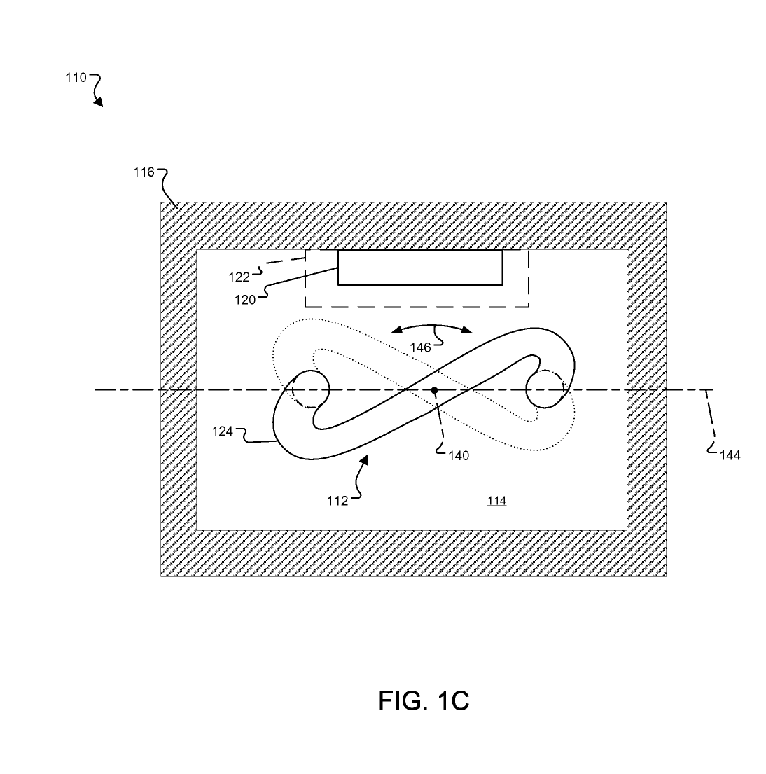

FIGS. 1A and 1B illustrate an exemplary apparatus 100 for use in measuring the densities of fluids. The apparatus 100 comprises a density-measuring device (DMD) 110 and associated control electronics 160. The DMD 110 includes a vibration element 112 that is enclosed within a chamber 114 of a housing 116. The vibration element 112 includes a passageway 118 through which fluid can flow. During use, the vibration element 112 is driven to vibrate by a time varying cyclical force applied to an excitation element 120 and the motion of the vibration element 112 is monitored via a detector 122 to measure the resonant frequency of the vibration element 112 which can then be used to determine the density of the fluid flowing in the passageway 118. That is, the resonant frequency of the vibration element 112 is a function of its mass which, when a fluid is flowing through the vibration element 112, is a function of the density of the fluid in the passageway 118.

The vibration element 112 includes a u-shaped flow-through member 124 that defines the fluidic passageway 118. The fluidic passageway 118 can have a cross-sectional area of about 100 square microns to about 50,000 square microns and a volume of 50,000 to 150,000,000 cubic microns. The flow-through member 124 has a wall thickness (t) of 10 microns to 20 microns. Generally, the smaller the wall thickness is, the more sensitive the device will be because the fluid within the tube will make up a greater proportion of the total mass of the vibration element 112.

The flow-through member 124 may be formed from a fused silica tube or fused silica capillary tubing comprising a fused silica capillary tube covered with a polyimide coating, metal tubing, a micromachined silicon structure, or diffusion-bonded titanium sheets, or a combination of such materials. In one example, the flow-through member 124 can be formed from a fused silica capillary tube having a 50 micron to 100 micron inner diameter fluidic passageway 118 and a 10 micron to 20 micron wall thickness. Fused silica can be preferable given its relatively high quality (Q) factor.

The flow-through member 124 includes an inlet segment 130 and an outlet segment 132 which are connected by a u-shaped connecting segment 134. Distal ends regions 136a, 136b of the inlet and outlet segments 130, 132 extend into and are mechanically secured (e.g., via clamping, laser welding, epoxy, etc.) to a base portion 136 of the housing 116 such that the flow-through member 124 is cantilever mounted within the chamber 114 and inlet and outlet portions of tubing forming the flow-through member 124 extend outwardly from the housing 116 to permit external fluidic connection to the vibration element 112.

Cross-members 138a, 138b extend between the inlet and outlet segments 130, 132 and are secured thereto (e.g., via laser welding, epoxy, etc.). The cross-members 138a, 138b help to inhibit (e.g., prevent) Coriolis force induced twisting of the vibration element 112 about longitudinal axis 140 (FIG. 1C) as it vibrates (as indicated by arrows 142) about vibration axis 144 (FIG. 1B). The cross-members 138a, 138b can also be useful for inducing movement and/or for measurement. Preferably, the cross-members 138a, 138b limit the amplitude of the Coriolis force induced twisting (as indicated by arrows 146, FIG. 1C) of the vibration element 112 to at least less than 1% of the amplitude of the non-twisting bending.

The housing 116 surrounding the vibration element 112 is formed of a rigid material such as metal and/or plastic, and the chamber 114 is evacuated to provide a vacuum which helps to reduce (e.g., eliminate) any influence of fluid surrounding the vibration element 112 that might otherwise change the resonant frequency of the vibration element 112. To induce vibration, excitation element 120 is provided in the chamber 114 and is positioned above one of the cross-members 138a. The excitation element 120, driven by control electronics 160, applies a time varying cyclical force. The force can be electrostatic, magnetic, and/or mechanical. In one example, the excitation element 120 is a conductive plate to provide an electrostatic force between the conductive plate and the cross-member to induce movement of the vibration element 112.

The detector 122 provides a signal (detected signal) representative of the excited frequency to the control electronics 160. In the illustrated example, the detector 122 includes a light source 148 and a photocell 150 is utilized for providing a signal representative of the excited frequency of vibration. The light source 148 (e.g., a light-emitting diode, laser diode, etc.) sends light in to reflect off one of the cross-members 138b, which may be provided with a polished, reflective surface, and the photocell 150 is arranged to measure the scattered light that reflects off of the vibration element 112 as an indication of phase angle. The measurements from the photocell 150 are delivered to the control electronics 160. Electrical connections to the detector 122 and/or the excitation element 120 can be made by passing conductive wires through walls of the housing 116, and openings for the conductive wires are sealed to support a vacuum in the chamber 114. While some conventional flow meters rely on Coriolis induced twisting for the purpose of measuring mass flow, this is undesirable for measuring density as the scattered light signal measured by photocell 150 will contain amplitude variations with frequency components relating to the Coriolis induced vibrations. This interferes with the ability of the control system to drive the sensor at resonance.

The control electronics 160 can include non-volatile memory with computer-readable instructions; and at least one processor for executing computer-readable instructions, receiving input, and sending output. The control electronics 160 can also include one or more digital-to-analog (D/A) converters for converting digital output from the at least one processor to an analog signal. The control electronics 160 can also include one or more analog-to-digital (A/D) converters for converting an analog signal, such as from the photocell 150, to a digital signal for input to the at least one processor. The control electronics 160 can also include a function generator, controlled via the at least one processor, to provide a sine wave signal to the excitation element 120. In some implementations, the control electronics 160 can include memory with computer-readable instructions for controlling operation of one or more devices such as fluid pumps, valves, etc. In some cases, various features of these control electronics can be integrated in a microcontroller.

The control electronics 160 use the measurements to modulate the sine-wave excitation signal in order to match the sine-wave frequency to the resonant frequency of the vibration element 112. In this regard, the control electronics 160 can modulate the excitation signal to maintain a constant phase angle of 90 degrees between the excitation signal and the detected signal. The excitation signal then becomes a measure of the resonant frequency which is affected by the mass of the vibration element 112, which, in turn, is affected by a density of a fluid within the vibration element 112. Once the resonant frequency is known, the control electronics 160 can calculate the fluid density from the following equation, for example:

$${ρ}_{fluid} = \frac{{m}_{element}}{{V}_{passageway}} ( {( \frac{{f}_{empty}}{{f}_{full}} )}^{2} - 1 )$$

Where, ρ_{fluid} is the density of the fluid in the passageway 118, which is to be calculated; mₑₗₑₘₑₙₜ is the mass of the vibration element 112, which is a known value; V_{passageway} is the internal volume of the passageway 118, a known value; f_{full} is the resonant frequency of the vibration element 112 filled with a fluid as measured with the apparatus 100, which is determined experimentally as described above; and f_{empty} is the resonant frequency of the vibration element 112 when the passageway 118 is empty, which may be determined experimentally by operating the apparatus 100 without any fluid flow.

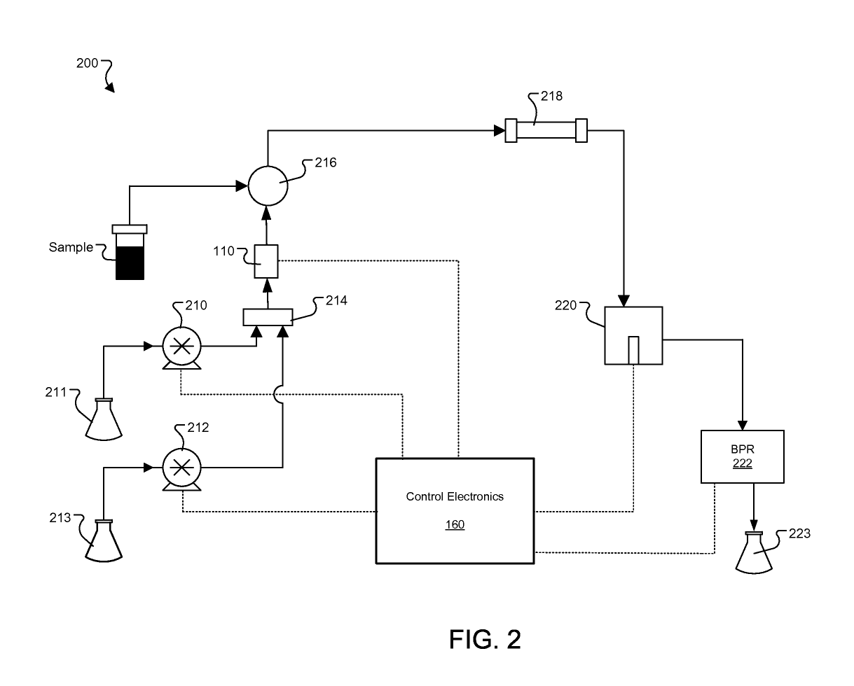

The apparatus may, for example, advantageously be utilized in a supercritical liquid chromatography (SFC) system to monitor density of the mobile phase (CO2). For example, FIG. 2 illustrates one implementation of an SFC system 200 that incorporates the apparatus 100 (FIG. 1A). The system 200 includes a first pump 210 which receives carbon dioxide (CO2) from CO2 source 211 (e.g., a tank containing compressed CO2). A second pump 212 receives an organic co-solvent (e.g., methanol, water (H2O), etc.) from a co-solvent source 213 and delivers it to the system 200.

The CO2 and co-solvent fluid flows from the first and second pumps 210, 212, respectively, and are mixed at a tee 214 forming a mobile phase fluid flow. The mobile phase fluid flow passes through the vibration element 112 (FIG. 1A) of the DMD 110 and then continues to an injector valve 216, which injects a sample plug for separation into the mobile phase fluid flow.

From the injector valve 216, the mobile phase flow containing the injected sample plug continues through a separation column 218, where the sample plug is separated into its individual component parts. After passing through the separation column 218, the mobile phase fluid flow continues on to a detection device 220 (e.g., a flow cell/photodiode array type detection device) then on to a back pressure regulator (BPR) 222 before being exhausted to waste 223.

Also shown schematically in FIG. 2 are the control electronics 160 which can assist in coordinating operation of the SFC system 200. In operation, the control electronics 160 set initial flow rates of the first and second pumps 210, 212. The control electronics 160 monitor the density of the mobile phase fluid flowing through the vibration element 112 and adjust the pressure setting of the BPR 222 to regulate system pressure in order to achieve and/or to maintain a desired fluid density of the mobile phase. Alternatively or additionally, the control electronics 160 can be configured to adjust the flow rate of the first pump 210 and/or the flow rate of the second pump 212, based on the detected fluid density, thereby to achieve and/or to maintain a desired density of the mobile phase fluid. As compared to the use of pressure sensors, the DMD 110 can provide a more direct means of monitoring and controlling the density of the mobile phase. In addition, since the DMD 110 is a flow-though device, the volume is swept. This can help to reduce the likelihood of band-spreading and dead volumes introduced by the apparatus 100 relative to some conventional pressure transducers.

Alternately or additionally, it may be advantageous for DMD 110 to be positioned between pump 210 and mixing tee 214, or between column 218 and BPR 222.

Also since the density of liquids is a function of temperature, it may be advantageous for both the temperature of the flowing fluid and of DMD 110 to be controlled.

### Other Implementations

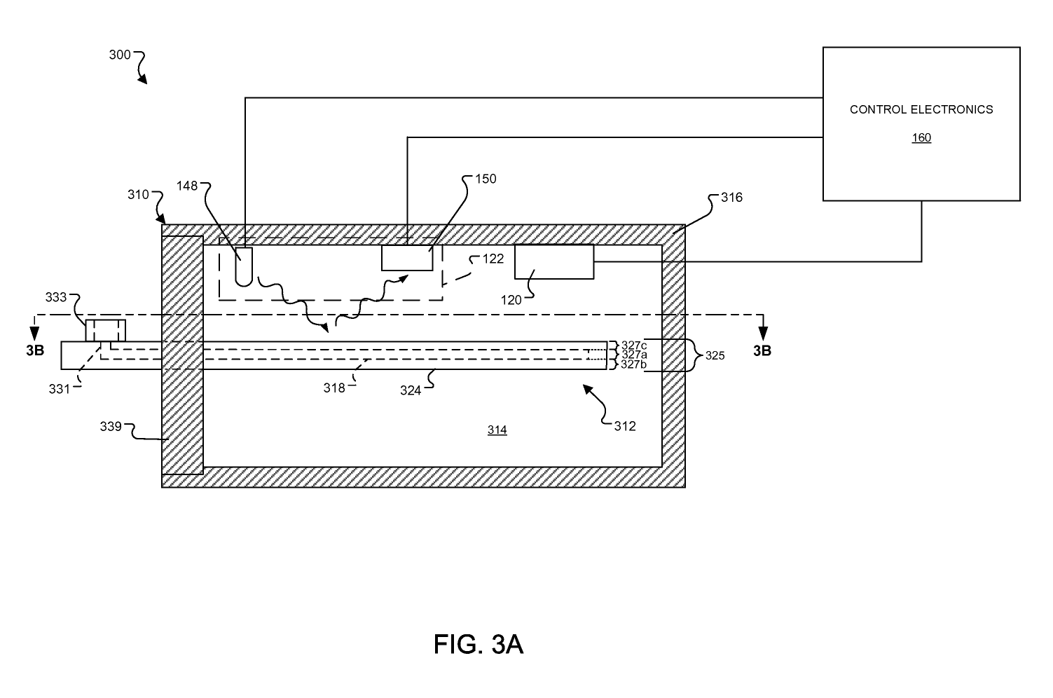

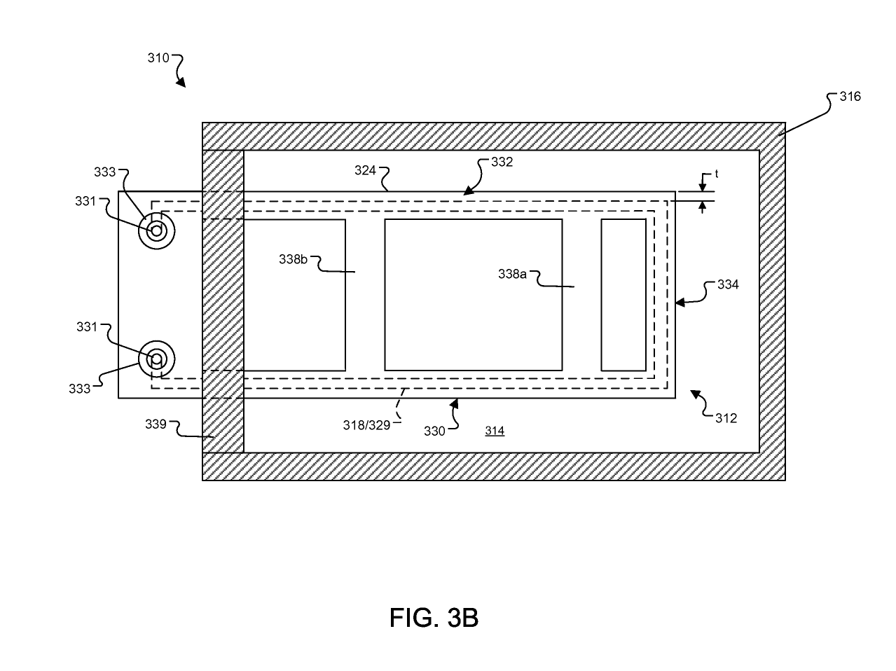

Although a few implementations have been described in detail above, other modifications are possible. For example, in some implementations, the flow-through member may be formed from a diffusion bonded titanium (Ti) substrate. FIGS. 3A and 3B illustrate an apparatus 300 for use in measuring the densities of fluids. The apparatus includes a DMD 310 comprising a u-shaped flow-through member 324 formed of a diffusion bonded titanium substrate 325. The substrate can be formed of three discrete substrate layers, including an inner substrate layer 327a, and a pair of outer substrate layers 327b, 327c. A u-shaped groove 329 is formed into the inner substrate layer 327a and through-holes 331 are formed in the first and/or the second outer substrate layer 327b, 327c. The three layers are then arranged such that the inner substrate layer 327a is disposed between the first and second outer substrate layers 327b, 327c, and the three layers are diffusion bonded together such that the inner substrate layer 327a and the first and second outer substrate layers 327b, 327c form a single substrate 325 having a homogenous structure.

After the three substrate layers are bonded together, the groove 329 formed in the inner substrate layer 327a is enclosed by the first and second outer substrate layers 327b, 327c, thereby providing an enclosed passageway 318 through which fluid can flow. The first and second outer substrate layers 327b, 327c form the outer surface of the diffusion bonded substrate 325, and the through-holes 331 formed in the first and/or the second outer substrate layers 327b, 327c form inlet and outlet openings 326, 328 allowing for fluid communication with the fluid passageway 318. In some cases, fittings 333 can be mounted to the outer surface of the diffusion bonded substrate 300 to assist in establishing fluidic connections between fluidic tubing and the through holes 331.

Portions of the substrate are etched away to define an inlet segment 330 and an outlet segment 332 which are connected by a connecting segment 334, and integral cross-members 338a, 338b that extend between the inlet and outlet segments 330, 332. As in the implementation described above with respect to FIGS. 1A and 1B, the cross-members 338a, 338b help to inhibit Coriolis force induced twisting of the vibration element 312 as it vibrates.

The substrate 325 is partially enclosed within an evacuated chamber 314 of a housing 316, with a distal end portion including the through-holes 331 extending outwardly from a base portion 339 of the housing 316 to permit fluidic connection to the vibration element 312. The substrate is mechanically secured (e.g., via laser welding or epoxy) to the base portion 339 of the housing 316 such that the flow-through member 324 of the vibration element 312 is cantilever mounted within the chamber 314.

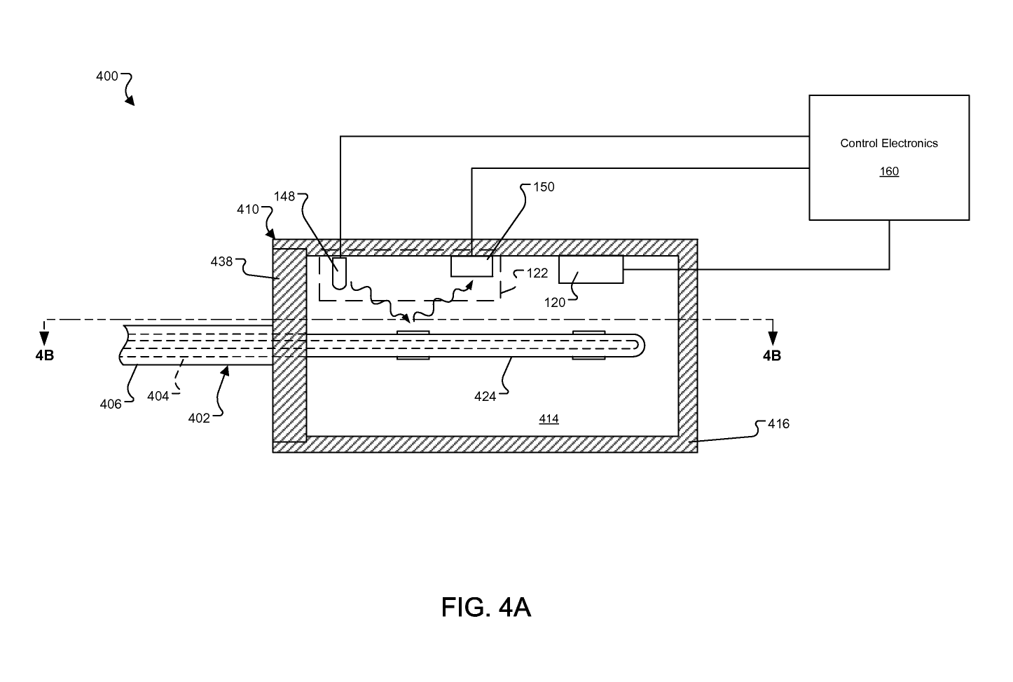

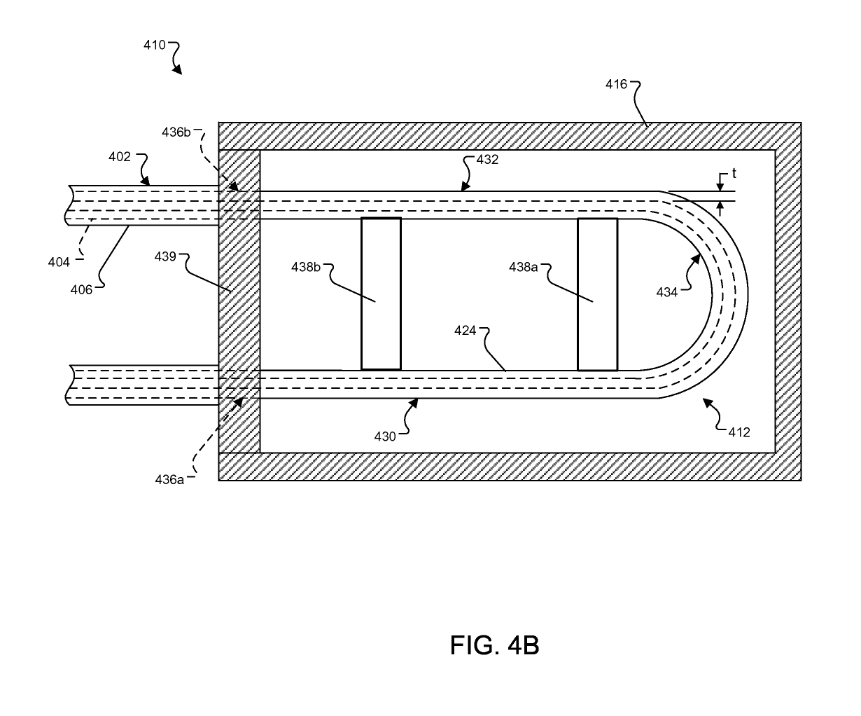

FIGS. 4A and 4B illustrate an implementation of an apparatus 400 for measuring fluid density in which a flow-through member 424 is formed from a fused silica capillary tubing 402. The tubing consists of a fused silica capillary tube 404 with a polyimide coating 406 on its outer surface. Such tubing is commercially available (e.g., from Polymicro Technologies of Phoenix, Ariz.) and is conventionally employed for fluid transfer in chromatography systems. The polyimide coating 406 is removed from a central portion of the tubing 402 to expose a portion of the fused silica capillary tube 404. The exposed portion of the fused silica capillary tube 404 is bent into a small loop which forms the flow-through member 424. The fused silica has good oscillatory response whereas the polyimide 406 has poor oscillatory response, which is why the polyimide 406 is removed to expose the fused silica tube 404.

As in the implementations described above, the flow-through member 424 includes an inlet segment 430 and an outlet segment 432 which are connected by a u-shaped connecting segment 434, and cross-members 438a, 438b are provided to help to inhibit (e.g., prevent) Coriolis force induced twisting of the vibration element 412. Distal ends regions 436a, 436b of the inlet and outlet segments 430, 432 extend into and are mechanically secured to a base portion 439 of a housing 416 such that the flow-through member 424 is cantilever mounted within an evacuated chamber 414 of the housing 416 and polyimide covered end portions of the tubing extend outwardly from the housing 416 to permit fluidic connection to the vibration element 412. Fittings, such as compression screw and ferrule fittings commonly used in chromatography applications, can be provided for connecting the fluidic tubing, e.g., to a separation column.

While an optical detector for providing a signal representative of the excited frequency have been described, other options for detection means may be in the form of, for example, magnetic means, or a strain gauge mounted to the surface of the vibration element.

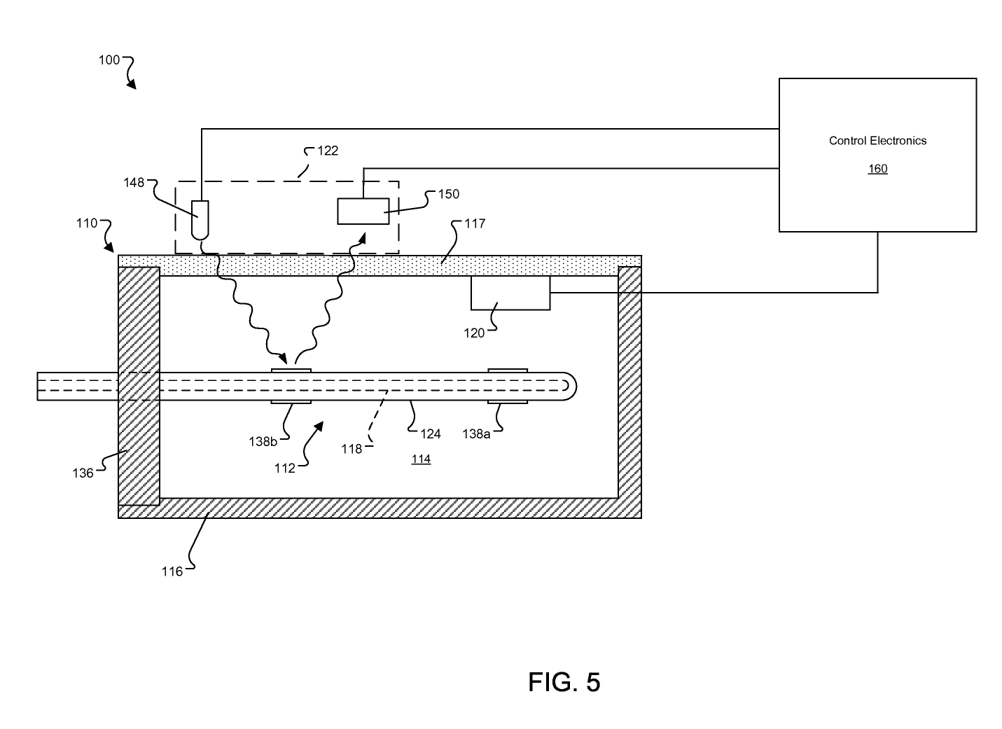

Furthermore, while a detector has been described as being inside of the housing, the detector may instead be disposed outside of the housing. For example, FIG. 5 illustrates an implementation in which the housing 116 comprises at least one transparent wall 117 (e.g., a glass or transparent plastic wall) and the detector 122, comprising the light source 148 and the photocell 150, is mounted externally to the housing 116 and is arranged to optically communicate with the vibration element 112 through the at least one transparent wall 117.

It may be advantageous, for example, in systems with splitters, to have more than one DMD-based control loop.

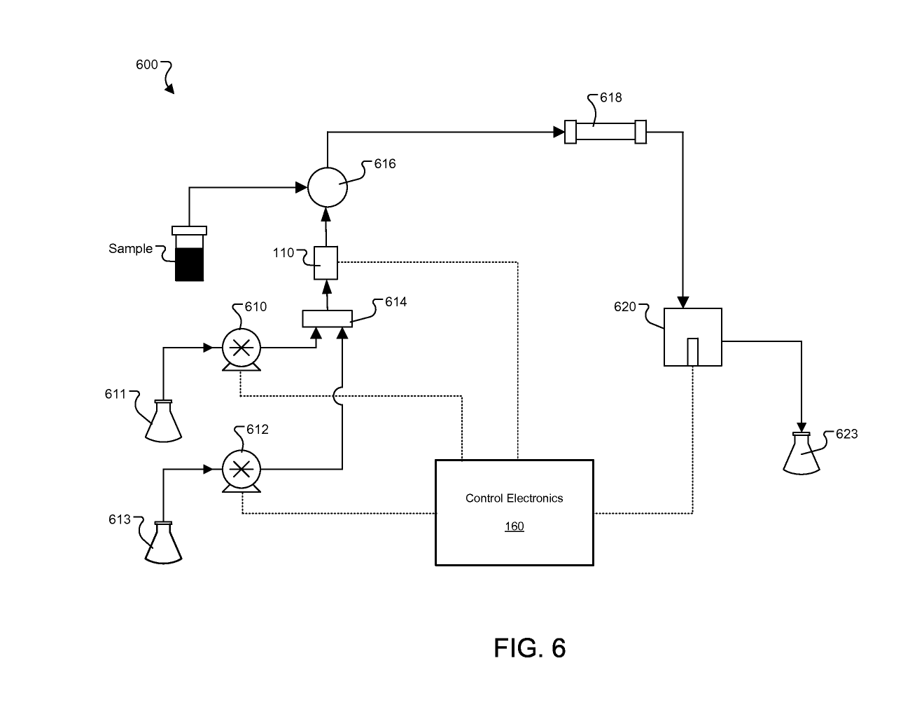

It may also be advantageous to incorporate apparatus for measuring fluid densities in conventional High Performance Liquid Chromatography (HPLC) and/or Ultra High Performance Liquid Chromatography (UHPLC) systems. For example, FIG. 6 illustrates an exemplary Liquid Chromatography (LC) system 600, which may be HPLC or UHPLC, that includes a first pump 610 which receives a first solvent (e.g., water) from a first source 611 and a second pump 612 which receives a second solvent (e.g., an organic solvent) from a second solvent source 613. Solvent flows from the first and second pumps 610, 612 are mixed at a mixing tee 614 forming a mixed mobile phase fluid flow. A downstream injector valve 616 introduces a sample into the mobile phase fluid flow, and, then, the mobile phase fluid flow continues through a separation column 618 and a detection device 620, before being exhausted to waste 623. In this illustrated example, a DMD 110 is used to measure the density of the mixed mobile phase fluid as it exits the mixing tee 614. The control electronics 160 can then use the measured density to determine whether the mixed mobile phase includes the desired proportions of the first and second solvents. And, if it is determined that the mixed mobile phase does not include the desired proportions of the first and second solvents, the control electronics 160 can then adjust the flow rates of the first and/or the second pump 610, 612 to achieve the desired proportions.

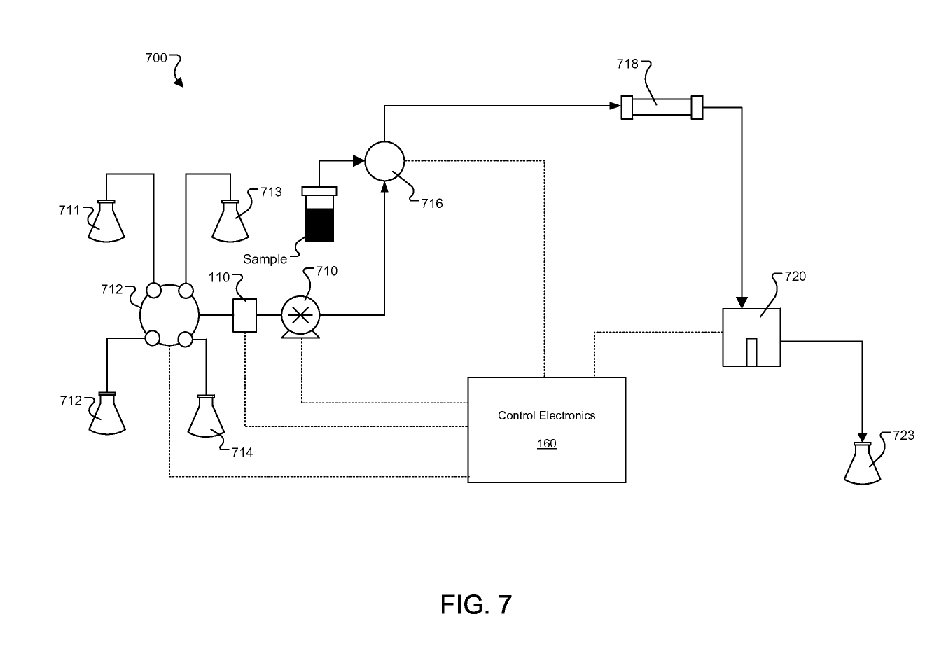

FIG. 7 illustrates another example of an LC system 700. The example illustrated in FIG. 7 includes a low pressure mixing scheme in which multiple solvent flows are mixed, under low pressure, ahead of a single pump 710. In this configuration, the proportioning valve 712 selects different solvents from different solvent sources 711, 713, 715, 717. The pump 710 delivers the mixed mobile phase fluid flow toward a downstream injector valve 716 which introduces a sample into the mixed mobile phase fluid flow. Then, the mobile phase fluid flow continues through a separation column 718 and a detection device 720, before being exhausted to waste 723.

In the illustrated example, a DMD 110 is positioned between the proportioning valve 712 and the pump 710 to measure the density of mixed mobile phase fluid. The control electronics 160 can then use the measured density to determine whether the mixed mobile phase includes the desired proportions of the solvents. And, if it is determined that the mixed mobile phase does not include the desired proportions of the first and second solvents, the control electronics 160 can then control operation of the proportioning valve 712 to achieve the desired solvent proportions.

Accordingly, other implementations are within the scope of the following claims.

What is claimed is:

1. An apparatus comprising
a vibration element defining a fluidic passageway;
an excitation element for exciting vibration of the vibration element;
a detector for providing a signal representative of the frequency excited; and
control electronics configured to determine a density of a fluid flowing through the fluidic passageway based, at least in part, on the signal provided by the detector,
wherein the vibration element is configured such that Coriolis force induced twisting of the vibration element is substantially inhibited.

2. The apparatus of claim 1, wherein the vibration element comprises a u-shaped flow-through member that defines the fluidic pathway.

3. The apparatus of claim 2, wherein the flow-through member comprises a fused silica tube.

4. The apparatus of claim 2, wherein the flow-through member comprises a diffusion bonded titanium substrate.

5. The apparatus of claim 2, wherein the flow-through member comprises an inlet segment and an outlet segment which are connected by a connecting segment, and
wherein the vibration element comprises one or more cross-members which extend between the inlet and outlet segments to inhibit Coriolis force induced twisting of the vibration element.

6. The apparatus of claim 1, further comprising a housing defining a chamber, wherein the vibration element is cantilever mounted within the chamber, and
wherein the chamber is evacuated to provide a vacuum.

7. The apparatus of claim 6, wherein the detector is mounted external to the housing, and wherein the housing comprises at least one transparent wall to allow optical communication between the detector and the vibration element.

8. A method comprising:
measuring a density of a mobile phase fluid in a chromatography system by passing the mobile phase fluid through a flow-through member of a DMD, and
controlling operation of one or more other devices of the chromatography system based on the measured density.

9. The method of claim 8, wherein measuring the density of the mobile phase fluid in the chromatography system comprises:
driving a vibration element comprising the flow-through member to vibrate; and
monitoring the vibration motion of the vibration element with a detector of the DMD.

10. The method of claim 9, wherein driving the vibration element comprises applying a sine-wave signal to an excitation element to excite vibration of the vibration element.

11. The method of claim 8, wherein the vibration element comprises one or more cross-members which inhibit Coriolis force induced twisting of the vibration element as it vibrates.

12. The method of claim 8, wherein controlling operation of the one or more other devices of the chromatography system comprises adjusting a pressure setting of a back pressure regulator of the chromatography system, and thereby adjusting the density of the mobile phase fluid.

13. The method of claim 8, wherein controlling operation of the one or more other devices of the chromatography system comprises adjusting a flow rate from a solvent delivery pump.

14. The method of claim 8, wherein controlling operation of the one or more other devices of the chromatography system comprises controlling operation of a proportioning valve to achieve desired proportions of solvents in the mobile phase fluid.

15. A chromatography system comprising:
a separation column;
a pump for delivering a mobile phase fluid flow to the separation column;
a vibration element defining a passageway in fluidic communication with the pump;
an excitation element for exciting vibration of the vibration element;
a detector for providing a signal representative of the frequency excited; and
control electronics configured to determine a density of the mobile phase fluid flow based, at least in part, on the signal provided by the detector.

16. The system of claim 15, wherein the control electronics are configured to adjust operation of the at least one pump based on the density of the mobile phase fluid flow.

17. The system of claim 15, further comprising a back pressure regulator for regulation an operating pressure of the system, wherein the control electronics are configured to adjust a pressure setting of the back pressure regulator based on the density of the mobile phase fluid flow.

18. The system of claim 15, further comprising a proportioning valve for regulation an operating pressure of the system, wherein the control electronics are configured to adjust a pressure setting of the back pressure regulator based on the density of the mobile phase fluid flow.

19. The system of claim 15, wherein the chromatography system is supercritical fluid chromatography system.

20. The system of claim 15, wherein the chromatography system is a liquid chromatography system.
